(19) United States
(12) Patent Application Publication
(10) Pub. No.: US 2022/0122343 A1
(43) Pub. Date: Apr. 21, 2022

(54) IMAGE FEATURE EXTRACTION AND NETWORK TRAINING METHOD, APPARATUS, AND DEVICE

(71) Applicant: SHENZHEN SENSETIME TECHNOLOGY CO., LTD., Shenzhen (CN)

(72) Inventors: Suichan LI, Shenzhen (CN); Dapeng CHEN, Shenzhen (CN); Rui ZHAO, Shenzhen (CN)

(21) Appl. No.: 17/566,740

(22) Filed: Dec. 31, 2021

Related U.S. Application Data
(63) Continuation of application No. PCT/CN2019/120028, filed on Nov. 21, 2019.

(30) Foreign Application Priority Data
Aug. 23, 2019 (CN) 201910782629.9

(51) Int. Cl. G06V 10/426; G06K 9/62; G06V 10/774; G06V 10/77

(52) U.S. Cl. CPC G06V 10/426; G06V 10/7715; G06V 10/774; G06K 9/6215

(57) ABSTRACT

Provided are a method, apparatus and device for image feature extraction and network training. The method includes the following. A first association graph including a main node and at least one neighbor node is acquired. A node value of the main node represents an image feature of a target image. A node value of each of the at least one neighbor node represents an image feature of a respective one of at least one neighbor image. The at least one neighbor image is similar to the target image. The first association graph is input into a feature update network. The feature update network updates the node value of the main node according to the node value of the at least one neighbor node in the first association graph, to obtain an updated image feature of the target image.

### CROSS-REFERENCE TO RELATED APPLICATIONS

This application is a continuation of International Application No. PCT/CN2019/120028, filed on Nov. 21, 2019, which claims priority to Chinese patent application No. 201910782629.9, filed on Aug. 23, 2019, and entitled “Method, Apparatus and Device for Image Feature Extraction and Network Training”. The disclosures of International Application No. PCT/CN2019/120028 and Chinese patent application No. 201910782629.9 are hereby incorporated by reference in their entireties.

### BACKGROUND

Image retrieval may include text-based image retrieval and Content Based Image Retrieval (CBIR) according to different ways of describing image content. The CBIR technology has broad application prospects in industrial fields such as e-commerce, leather cloth, copyright protection, medical diagnosis, public safety, and street view maps.

### SUMMARY

The disclosure relates to a computer vision technology, and more particularly, to a method, apparatus and device for image feature extraction and network training.

In a first aspect, provided is a method for image feature extraction, including: acquiring a first association graph including a main node and at least one neighbor node, wherein a node value of the main node represents an image feature of a target image, a node value of each of the at least one neighbor node represents an image feature of a respective one of at least one neighbor image, and the at least one neighbor image is similar to the target image; and inputting the first association graph into a feature update network, and updating, by the feature update network, the node value of the main node according to the node value of the at least one neighbor node in the first association graph, to obtain an updated image feature of the target image.

In a second aspect, provided is a method for training a feature update network, the feature update network being configured to update an image feature of an image, and the method including: acquiring a second association graph including a training main node and at least one training neighbor node, wherein a node value of the training main node represents an image feature of a sample image, a node value of each of the at least one training neighbor node represents an image feature of a respective one of at least one training neighbor image, and the at least one training neighbor image is similar to the sample image; inputting the second association graph into the feature update network, and updating, by the feature update network, the node value of the training main node according to the node value of the at least one training neighbor node in the second association graph, to obtain an updated image feature of the sample image; obtaining predicted information of the sample image according to the updated image feature of the sample image; and adjusting a network parameter of the feature update network according to the predicted information.

In a third aspect, provided is an apparatus for image feature extraction, including: a graph acquisition module, configured to acquire a first association graph including a main node and at least one neighbor node, wherein a node value of the main node represents an image feature of a target image, a node value of each of the at least one neighbor node represents an image feature of a respective one of at least one neighbor image, and the at least one neighbor image is similar to the target image; and a feature update module, configured to input the first association graph into a feature update network, and update, by the feature update network, the node value of the main node according to the node value of the at least one neighbor node in the first association graph, to obtain an updated image feature of the target image.

In a fourth aspect, provided is an apparatus for training a feature update network, including: an association graph obtaining module, configured to acquire a second association graph including a training main node and at least one training neighbor node, wherein a node value of the training main node represents an image feature of a sample image, a node value of each of the at least one training neighbor node represents an image feature of a respective one of at least one training neighbor image, and the at least one training neighbor image is similar to the sample image; an update processing module, configured to input the second association graph into the feature update network, and update, by the feature update network, the node value of the training main node according to the node value of the at least one training neighbor node in the second association graph, to obtain an updated image feature of the sample image; and a parameter adjustment module, configured to obtain predicted information of the sample image according to the updated image feature of the sample image, and adjust a network parameter of the feature update network according to the predicted information.

In a fifth aspect, provided is an electronic device, including a memory and a processor, wherein the memory is configured to store computer instructions executable by the processor, and the processor is configured to execute the computer instructions to: acquire a first association graph comprising a main node and at least one neighbor node, wherein a node value of the main node represents an image feature of a target image, a node value of each of the at least one neighbor node represents an image feature of a respective one of at least one neighbor image, and the at least one neighbor image is similar to the target image; and input the first association graph into a feature update network, and update, by the feature update network, the node value of the main node according to the node value of the at least one neighbor node in the first association graph, to obtain an updated image feature of the target image.

In a sixth aspect, provided is a non-transitory computer-readable storage medium having a computer program stored thereon, wherein the program, when executed by a processor, implements a method for image feature extraction, the method comprising: acquiring a first association graph comprising a main node and at least one neighbor node, wherein a node value of the main node represents an image feature of a target image, a node value of each of the at least one neighbor node represents an image feature of a respective one of at least one neighbor image, and the at least one neighbor image is similar to the target image; and inputting the first association graph into a feature update network, and updating, by the feature update network, the node value of the main node according to the node value of the at least one neighbor node in the first association graph, to obtain an updated image feature of the target image.

In a seventh aspect, provided is a computer program for causing a processor to perform the steps of the method for image feature extraction according to any one of the embodiments of the disclosure, or steps of the method for training a feature update network according to any one of the embodiments of the disclosure.

### BRIEF DESCRIPTION OF THE DRAWINGS

In order to more clearly illustrate the technical solutions in one or more embodiments of the disclosure or the related art, the drawings used in the description of the embodiments or the related art will be briefly described below. It is apparent that the drawings in the following description are only some of one or more embodiments of the disclosure, and other drawings can be obtained from those skilled in the art according to these drawings without any creative work.

FIG. 1 illustrates a method for image feature extraction according to at least one embodiment of the disclosure.

FIG. 2 illustrates a processing flow of a feature update network according to at least one embodiment of the disclosure.

FIG. 3 illustrates a method for training a feature update network according to at least one embodiment of the disclosure.

FIG. 4 illustrates a method for training a feature update network according to at least one embodiment of the disclosure.

FIG. 5 illustrates a schematic diagram of an acquired neighbor image according to at least one embodiment of the disclosure.

FIG. 6 illustrates a schematic diagram of an association graph according to at least one embodiment of the disclosure.

FIG. 7 illustrates an image retrieval method provided in at least one embodiment of the disclosure.

FIG. 8 illustrates a schematic diagram of a sample image and library images according to at least one embodiment of the disclosure.

FIG. 9 illustrates a schematic diagram of searching for a neighbor image according to at least one embodiment of the disclosure.

FIG. 10 illustrates a network structure of a feature update network according to at least one embodiment of the disclosure.

FIG. 11 illustrates an apparatus for image feature extraction according to at least one embodiment of the disclosure.

FIG. 12 illustrates an apparatus for image feature extraction according to at least one embodiment of the disclosure.

FIG. 13 illustrates an apparatus for training a feature update network according to at least one embodiment of the disclosure.

FIG. 14 illustrates an apparatus for training a feature update network according to at least one embodiment of the disclosure.

### DETAILED DESCRIPTION

In order to enable those skilled in the art to better understand the technical solutions in one or more embodiments of the disclosure, the technical solutions in one or more embodiments of the disclosure will be described clearly and completely below in conjunction with the drawings in one or more embodiments of the disclosure. It is apparent that the described embodiments are only part of the embodiments of the disclosure, rather than all the embodiments. All other embodiments obtained by those skilled in the art based on one or more embodiments of the disclosure without creative efforts shall fall within the scope of protection of the disclosure.

Image retrieval may include text-based image retrieval and CBIR according to different ways of describing image content. In one embodiment, when performing image retrieval based on content, a computer may be used to extract an image feature, establish vector description of the image feature and save the vector description of the image feature into an image feature library. When a user inputs a query image, the same feature extraction method may be used to extract an image feature of the query image to obtain a query vector; then similarities between the query vector and image features in an image feature library are calculated under a similarity measurement criterion. At last, corresponding pictures are sorted and sequentially output according to magnitudes of the similarities. In the present embodiment, it may be found that retrieval of a target object may be easily affected by a shooting environment. For example, illumination changes, scale changes, viewing angle changes, occlusion, and clutter of background may all affect the retrieval result.

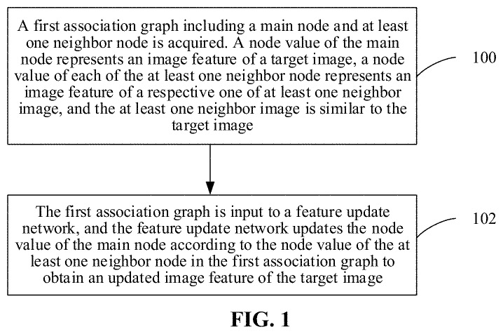

In view of this, in order to improve the accuracy of image retrieval, a method for image feature extraction is provided in embodiments of the disclosure. FIG. 1 illustrates a method for image feature extraction according to at least one embodiment of the disclosure. As illustrated in FIG. 1, the method may include the following processing.

In S100, a first association graph including a main node and at least one neighbor node is acquired. A node value of the main node represents an image feature of a target image, a node value of each of the at least one neighbor node represents an image feature of a respective one of at least one neighbor image, and the at least one neighbor image is similar to the target image.

In the present action, the target image is an image from which an image feature is to be extracted. The image may be an image in different application scenarios. Exemplarily, it may be an image to be retrieved in an image retrieval application, and the image library described below may be a retrieval image library in the image retrieval application.

For example, a neighbor image may be obtained before the first association graph is acquired. A neighbor image similar to the target image is acquired from an image library according to the target image. Exemplarily, the neighbor image may be determined according to an image feature similarity measurement criterion. For example, an image feature of the target image and an image feature of each of library images in the image library are respectively acquired through a feature extraction network, and a neighbor image similar to the target image is determined from the image library based on feature similarities between the image feature of the target image and image features of the library images in the image library.

In one embodiment, the feature similarities between the target image and the library images may be sorted in a descending order of numeric values of the feature similarities. Library images corresponding to the feature similarities ranking at top N are selected as neighbor images similar to the target image. N is a preset number, such as 10.

In another embodiment, it is also possible to firstly acquire a first image similar to the target image according to the similarity between image features, then acquire a second image similar to the first image, and take both the first image and the second image as neighbor images of the target image.

In S102, the first association graph is input to a feature update network, and the feature update network updates the node value of the main node according to the node value of the neighbor node in the first association graph to obtain an updated image feature of the target image.

For example, the feature update network may be an Attention-based Graph Convolution (AGCN) module, or may be other modules, which will not be limited.

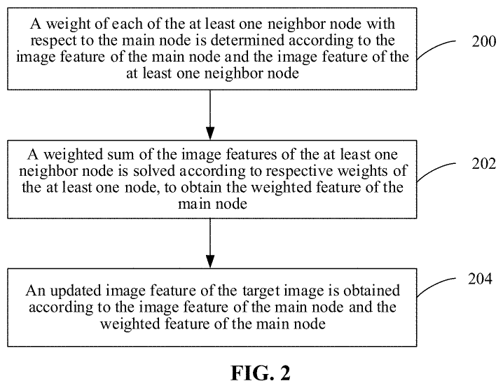

With the feature update network being a graph convolution module as an example, the graph convolution module in the present action may update the node value of the main node according to the node value of the at least one neighbor node. For example, a weight of each of the at least one neighbor node with respect to the main node may be determined in the first association graph, image features of the at least one neighbor node are merged according to respect weights of the at least one neighbor node, to obtain a weighted feature of the main node, and the updated image feature of the target image is obtained according to the image feature of the main node and the weighted feature of the main node. The subsequent flow illustrated in FIG. 2 exemplarily describes the specific process of updating the node value of the main node by the graph convolution module.

In actual implementation, there may be one graph convolution module, or multiple successively stacked graph convolution modules. Exemplarily, when there are two graph convolution modules, the first association graph is input to a first graph convolution module. The first graph convolution module updates the image feature of the main node according to the image features of the neighbor nodes. The first association graph output by the first graph convolution module is an updated first association graph in which the image feature of the main node has been updated. The updated first association graph is continuously input into a second graph convolution module. The second graph convolution module continuously updates the image feature of the main node according to the image features of the neighbor nodes, and outputs a first association graph that has been updated again, with the image feature of the main node having been updated again.

The first association graph in the present embodiment includes multiple nodes (for example, a main node, and a neighbor node), and a node value of each node indicates an image feature of an image represented by the node. In addition, each node in the first association graph may serve as a main node, and the image feature of the image corresponding to the node is updated by the method described in FIG. 1 of the present embodiment. For example, when the node serves as a main node, a first association graph in which the node serves as a main node is acquired, and the first association graph is input into the feature update network to update the image feature of the node.

In the method for image feature extraction of the present embodiment, the feature update network of the embodiment of the disclosure is used to update and extract image features. Because the feature update network updates the image feature of the main node according to the image features of the neighbor nodes of the main node, the updated image feature of the target image can express the target image more accurately, and is more robust and discriminative in the image recognition process.

FIG. 2 illustrates a processing flow of a feature update network in an embodiment. The flow describes how the feature update network updates an image feature of an image input into the network. As illustrated in FIG. 2, with the feature update network being a graph convolution module as an example, the processing flow of the feature update network may include the following actions 200-204.

In S200, a weight of each of the at least one neighbor node with respect to the main node is determined according to the image feature of the main node and the image feature of the at least one neighbor node.

In the present action, the main node may represent a target image in a network application stage, and the neighbor node may represent a neighbor image of the target image.

For example, the weight of the neighbor node with respect to the main node may be determined according to the following formula (1):

$${a}_{i} = \frac{exp ( ReLU ( F ( {W}_{i} {z}_{vi} , {W}_{u} {z}_{u} ) )}{{\sum }_{k} exp ( ReLU ( F ( {W}_{k} {z}_{vk} , {W}_{u} {z}_{u} ) )} \qquad ( 1 )$$

Firstly, linear transformation may be performed on the image feature zᵤ of the main node and the image feature zᵥᵢ of the neighbor node, where vi represents one of the neighbor nodes of the main node, and k represents the number of neighbor nodes. Wᵢ and Wᵤ are coefficients of linear transformation.

Next, an inner product of the image feature of the main node and the image feature of the neighbor node that have subjected to the linear transformation may be determined. The inner product may be calculated by a function F. Then, nonlinear transformation is realized through a Rectified Linear Unit (ReLU), and finally the weight is obtained after performing softmax operation. As illustrated in formula (1), the weight aᵢ is the weight of the neighbor node vi with respect to the main node u.

In addition, the calculation of the weight of the neighbor node with respect to the main node in the present action is not limited to the above formula (1). For example, the value of the similarity between the image features of the main node and the neighbor node may also be used as a weight of the neighbor node with respect to the main node.

In S202, a weighted sum of the image features of the at least one neighbor node is solved according to respective weights of the at least one node, to obtain the weighted feature of the main node.

For example, nonlinear mapping may be performed on the image feature of each neighbor node of the main node, then the weight obtained in S200 may be used to solve the weighted sum of the image features of the at least one neighbor node having subjected to the nonlinear mapping. The obtained feature may be referred to as a weighted feature, as illustrated in the following formula (2):

nᵤ=ΣₖaᵢReLU(Qzᵥᵢ+q) (2)

In formula (2), nᵤ is the weighted feature, zᵥᵢ is the image feature of the neighbor node, and aᵢ is the weight calculated in S200. Q and q are coefficients of nonlinear mapping.

In S204, an updated feature of the target image is obtained according to the image feature of the main node and the weighted feature of the main node.

In the present action, the image feature of the main node in the initially obtained association graph and the weighted feature may be concatenated together, and then nonlinearly mapped, as illustrated in the following formula (3):

zᵤ^{new}=ReLU(Wconcat(zᵤ,nᵤ)+w) (3)

zᵤ is the image feature of the main node in the association graph, nᵤ is the weighted feature, nonlinear mapping is performed through ReLU, and W and w are coefficients of nonlinear mapping.

Finally, the feature obtained by formula (3) is normalized, as illustrated in the following formula (4), to obtain a finally updated image feature zᵤ^{new} of the main node.

$${z}_{u}^{new} = \frac{{z}_{u}^{new}}{{‖ {z}_{u}^{new} ‖}_{2}} \qquad ( 4 )$$

Through the above actions 200 to 204, the node value of the main node in the first association graph is updated, and the updated image feature of the main node is obtained.

In the processing flow of the feature update network of the present embodiment, the graph convolution module is used to solve a weighted sum of the image features of the neighbor nodes of the main node to determine the weighted feature of the main node. Thus, the image feature of the target image itself and the image features of the neighbor images associated with the target image can be comprehensively considered. The updated image feature of the target image is more robust and discriminative, and the accuracy of image retrieval is improved.

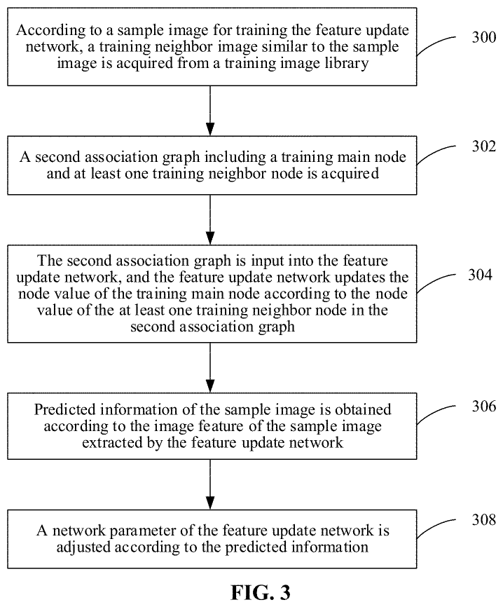

FIG. 3 illustrates a method for training a feature update network according to at least one embodiment of the disclosure. As illustrated in FIG. 3, the method describes the process of training the feature update network, which may include the following processing:

In S300, according to a sample image for training the feature update network, a training neighbor image similar to the sample image is acquired from a training image library.

It should be noted that in the phrases “training image library” and “training neighbor image” in the present embodiment, the word “training” is used to indicate that an item is applied in the network training stage and is distinguished in name from the neighbor image and the image library mentioned in the network application stage, without constituting any restriction. In the same way, the phrases “training main node” and “training neighbor node” mentioned in the following description are also only distinguished in name from the same concepts in the network application stage, without constituting any restriction.

When training the feature update network, the training may be performed in a group-wise manner. For example, training samples may be divided into multiple image batches, an image batch is input to the feature update network in each iteration of training. The loss of each sample image contained in the image batch is combined, and a network parameter is adjusted through back propagation of the losses to the network. After one iteration of training is completed, a next image batch may be input into the feature update network for a next iteration of training.

In the present action, each image in an image batch may be referred to as a sample image. The processing in actions 300 to 306 may be performed for each sample image, and the loss may be obtained according to predicted information and label information.

Exemplarily, in an application scenario of image retrieval, the training image library may be a retrieval image library, that is, an image similar to a sample image is retrieved from the retrieval image library. The similarity may include: containing a same object as the sample image, or belonging to the same category as the sample image.

In the present action, an image similar to the sample image may be referred to as a “training neighbor image”.

The training neighbor image may be obtained in the following way: for example, determining an image with a higher similarity as a training neighbor image according to a feature similarity between images.

In S302, a second association graph including a training main node and at least one training neighbor node is acquired. A node value of the training main node represents an image feature of a sample image, a node value of each of the at least one training neighbor node represents an image feature of a respective one of at least one training neighbor image, and the at least one training neighbor image is similar to the sample image.

For example, an association graph in the network training stage may be referred to as a second association graph, and an association graph that appeared above in the network application stage may be referred to as a first association graph.

In the present action, the second association graph may include multiple nodes.

The nodes in the second association graph may include: a training main node and at least one training neighbor node. The training main node represents a sample image, and each training neighbor node represents a training neighbor image determined in S300. The node value of each node represents an image feature. For example, the node value of the training main node represents the image feature of the sample image, and the node value of the training neighbor node represents the image feature of the training neighbor image.

In S304, the second association graph is input into the feature update network, and the feature update network updates the node value of the training main node according to the node value of the at least one training neighbor node in the second association graph.

For example, the feature update network may be a graph convolution module, or may be another type of module, which will not be limited here. In the present action, the graph convolution module is an AGCN, which is configured to update the image feature of the training main node according to the image features of the training neighbor nodes in the second association graph. For example, the image feature of the training main node may be updated after solving the weighted sum of the image features of the training neighbor nodes.

In actual implementation, there may be one graph convolution module, or successively stacked multiple graph convolution modules. Exemplarily, when there are two graph convolution modules, the second association graph is input to a first graph convolution module. The first graph convolution module updates the image feature of the training main node according to the image features of the training neighbor nodes. The second association graph output by the first graph convolution module is an updated second association graph in which the image feature of the training main node has been updated. The updated second association graph is continuously input into a second graph convolution module. The second graph convolution module continuously updates the image feature of the training main node according to the image features of the training neighbor nodes, and outputs the image feature of the training main node that has been updated again.

In S306, predicted information of the sample image is obtained according to the image feature of the sample image extracted by the feature update network.

In the present action, the predicted information of the sample image may be further determined according to the image features extracted by the graph convolution module. For example, a classifier may be connected after the graph convolution module, and the classifier obtains, according to the image feature, the probability that the sample image belongs to each preset category.

In S308, a network parameter of the feature update network is adjusted according to the predicted information.

In the present action, the loss corresponding to the sample image may be determined according to the difference between predicted information output by the feature update network and label information. As mentioned above, with a graph convolution module as an example, in performing group-wise training with multiple batches, the network parameter of the graph convolution module may be adjusted by back propagation according to the loss of each sample image in a batch, so that the graph convolution module extracts image features more accurately according to the adjusted network parameter.

For example, when adjusting the network parameter of the graph convolution module according to the loss by back propagation, the coefficients such as Wᵢ, Wᵤ, Q, q, W, and w of the graph convolution module mentioned in the flow description of FIG. 2 may be adjusted.

In the method for training a feature update network of the present embodiment, an image feature of a sample image is updated by combining images similar to the sample image when training the network, so that the image feature of the sample image itself and image features of training neighbor images associated with the sample image can be comprehensively considered. The image feature of the sample image obtained by using the trained feature update network is more robust and discriminative, to improve the accuracy of image retrieval. For example, even affected by illumination changes, scale changes, and viewing angle changes, a relatively accurate image feature may still be obtained.

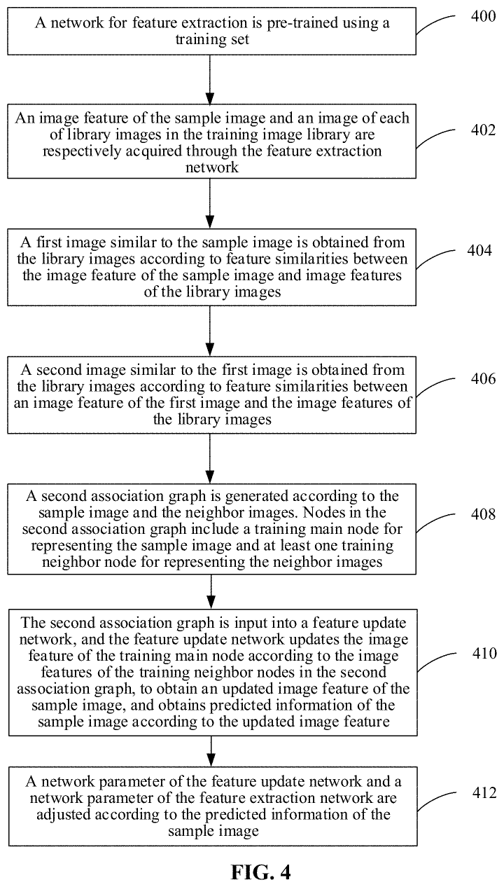

FIG. 4 illustrates a method for training a feature update network according to another embodiment. In this method, image features may be extracted through a pre-trained network for feature extraction (which may be referred to as a feature extraction network), and similarity measurement may be performed according to the image features, so as to acquire, from a training image library, a training neighbor image similar to a sample image. As illustrated in FIG. 4, the method may include the following actions.

In S400, a network for feature extraction is pre-trained using a training set.

For example, the pre-trained network for feature extraction may be referred to as a feature extraction network, including but not limited to, a Convolutional Neural Network (CNN), a Back Propagation (BP) neural network, a discrete Hopfield network, etc.

The images in the training set may be referred to as training images. The process of training the feature extraction network may include: an image feature of a training image is extracted through a feature extraction network; predicted information of the training image is obtained according to the image feature of the training image; and a network parameter of the feature extraction network is adjusted based on the predicted information of the training image and label information.

It should be noted that the above training image refers to an image used to train the feature extraction network, and the sample image mentioned earlier refers to an image which will be applied to a process of training the feature update network after the training of the feature extraction network is completed. For example, through the pre-trained feature extraction network, the image features of the sample image and each library image in the training image library are firstly extracted, and an association graph is then generated and input into the feature update network for image feature update. The input image used in the process of training the feature update network is the sample image. The sample image and the training image may be the same or different from each other.

In S402, an image feature of the sample image and an image of each of library images in the training image library are respectively acquired through the feature extraction network.

In S404, a first image similar to the sample image is obtained from the library images according to feature similarities between the image feature of the sample image and image features of the library images.

In the present action, the library images are images in a retrieval image library.

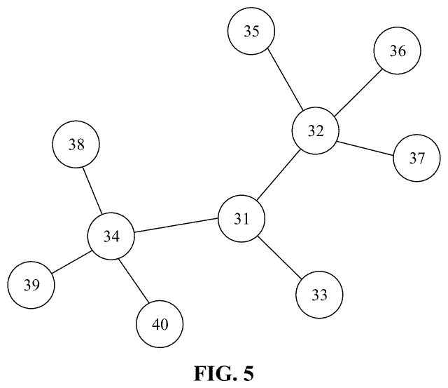

Exemplarily, the feature similarities between the image feature of the sample image and the image features of the library images may be calculated respectively, and the library images may be sorted according to the similarities. For example, the library images are sorted in a descending order of the similarities. Then, the library image ranking at the top K are selected from the ranking result as the first images of the sample image. For example, referring to FIG. 5, a node 31 represents a sample image, and the library images represented by a node 32, a node 33, and a node 34 are all first images that are similar to the sample image.

In S406, a second image similar to the first image is obtained from the library images according to feature similarities between an image feature of the first image and the image features of the library images.

In the present action, the feature similarities between the image feature of the first image and the image features of the library image may be calculated, and a library image similar to the first image is obtained from the library images as a second image. For example, referring to FIG. 5, through measurement of similarities between image features, nodes 35 to 37 are library images similar to the node 32, and the nodes 35 to 37 are second images similar to the node 31. Similarly, nodes 38 to 40 similar to the node 34 are also second images similar to the node 31.

In addition, FIG. 5 illustrates an example situation. In actual implementation, search of a neighbor image may be stopped when the first image similar to the main node corresponding to the sample image is found. Alternatively, a larger number of neighbor images such as a third image or a fourth image may also be found. The specific number of layers of neighbor images to be searched may be determined according to the effect of actual tests in different application scenarios. The above first image, second image, etc. may all be referred to as neighbor images, which may be referred to as training neighbor images in the network training stage, and may be referred to as neighbor images in the network application stage.

It should also be noted that the neighbor image may also be obtained in other ways than the example in the present action. For example, a similarity threshold may be set, and all or part of the library images having feature similarities higher than the threshold are directly taken as neighbor images of the sample image. For another example, instead of using a feature extraction network to extract image features, image features may also be based on values of the image in multiple dimensions.

In S408, a second association graph is generated according to the sample image and the neighbor images. Nodes in the second association graph include a training main node for representing the sample image and at least one training neighbor node for representing the neighbor images. A node value of the training main node is an image feature of the sample image. A node value of the training neighbor node is an image feature of the neighbor image. In one embodiment, the neighbor images in the present action include the first image obtained in S404 and the second image obtained in S406.

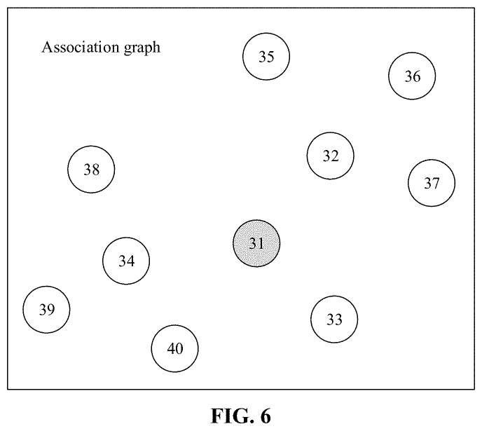

The second association graph generated in the present action is a graph including multiple nodes, which may refer to the example in FIG. 6. The node 31 in FIG. 6 is a training main node, and all other nodes are training neighbor nodes. The node value may represent an image feature of the image represented by the node, and the image feature may be extracted in S402, for example.

In S410, the second association graph is input into a feature update network, and the feature update network updates the image feature of the training main node according to the image features of the training neighbor nodes in the second association graph, to obtain an updated image feature of the sample image, and obtains predicted information of the sample image according to the updated image feature.

In S412, a network parameter of the feature update network and a network parameter of the feature extraction network are adjusted according to the predicted information of the sample image.

The network parameter adjustment in the present action may or may not include adjusting the network parameter of the feature extraction network, which may be determined according to the actual training situation.

In the method for training a feature update network of the present embodiment, an image feature of a sample image is updated by combining images similar to the sample image when training the network, so that the image feature of the sample image itself and image features of other images associated with the sample image can be comprehensively considered. Thus, the image feature of the sample image obtained by using the trained feature update network is more robust and discriminative, to improve the accuracy of image retrieval. Moreover, by using a feature extraction network to extract image features, not only the efficiency of image feature extraction can be improved, thus improving the speed of network training, but also the network parameter of the feature extraction network can be adjusted according to losses, so that the image features extracted by the feature extraction network are more accurate.

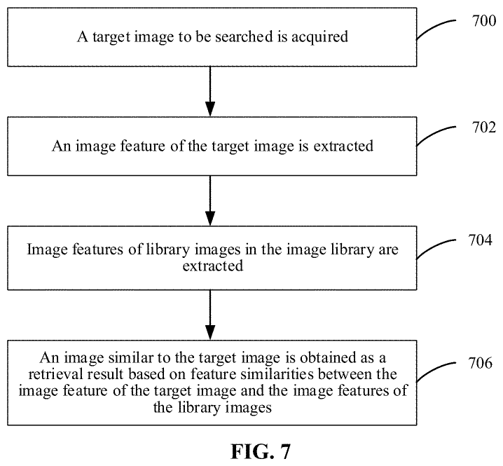

In embodiments of the disclosure, also provided is a method for retrieving an image, which is to retrieve, from an image library, an image similar to a target image. As illustrated in FIG. 7, the method may include the following processing.

In S700, a target image to be retrieved is acquired.

For example, if an image that contains a same object as an image M is to be retrieved from an image library, the image M may be referred to as a target image. That is, images that have a certain association with the target image are to be retrieved from the image library. This association may include: containing the same object or belonging to the same category.

In S702, an image feature of the target image is extracted.

In the present action, the image feature may be extracted by the method for image feature extraction according to any one of the embodiments of the disclosure.

In S704, image features of library images in the image library are extracted.

In the present action, image features of library images in the image library may be extracted according to the method for image feature extraction in any one of the embodiments of the disclosure, for example, the extraction method illustrated in FIG. 1.

In S706, an image similar to the target image is obtained as a retrieval result based on feature similarities between the image feature of the target image and the image features of the library images.

In the present action, the feature similarity measurement may be performed between the image feature of the target image and the image features of the library images, so that a similar library image is taken as the retrieval result.

In the image retrieval method of the present embodiment, since the extracted sample image features are more robust and discriminative, the accuracy of the retrieval result is improved.

Image retrieval may be applied to a variety of scenarios, such as medical diagnosis, street view maps, intelligent video analysis, and security monitoring. The person search in security monitoring is taken as an example as follows to describe how to apply the method of the embodiment of the disclosure to train the network for use in retrieval and how to use the network to perform image retrieval. In the following description, network training and its application will be explained separately.

Network Training

A network may be trained in a group-wise training manner. For example, training samples may be divided into multiple image batches. In each iteration of training, sample images in a batch are input into the feature update network to be trained one by one, and a network parameter of the feature update network is adjusted in combination with losses of the sample images contained in the image batch.

One sample image is taken as an example below to describe how to obtain a loss corresponding to the sample image.

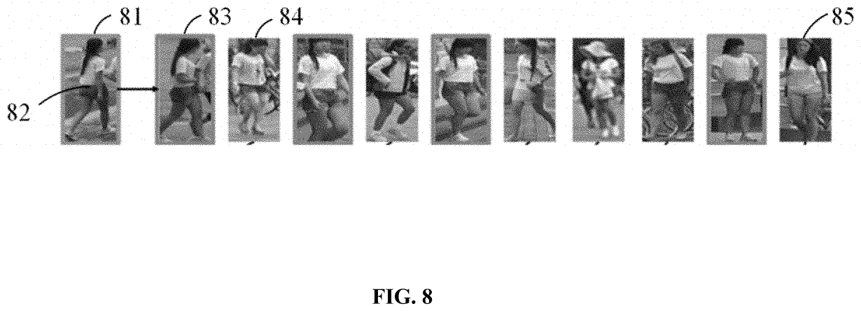

As illustrated in FIG. 8, a sample image 81 includes a person 82. The goal of the person search in the present embodiment is to search a retrieval image library for a library image that containing the same person 82.

It is assumed that a network for extracting image features has been pre-trained, for example, a CNN network, which may be referred to as a feature extraction network. The image feature of the sample image 81 and image features of library images in the image library are respectively extracted through the feature extraction network. The feature similarities between the sample image 81 and the library images are then calculated, and according to the rank of similarities, library images ranking at a preset top number (for example, ranking at top 10 in a descending order of similarities) are selected as images similar to the sample image 81, and may be referred to as neighbor images of the sample image 81. Referring to FIG. 8, the library image 83, the library image 84, till the library image 85 are all neighbor images. The person contained in these neighbor images may indeed be the same as the person 82, or may be different but very similar to the person 82.

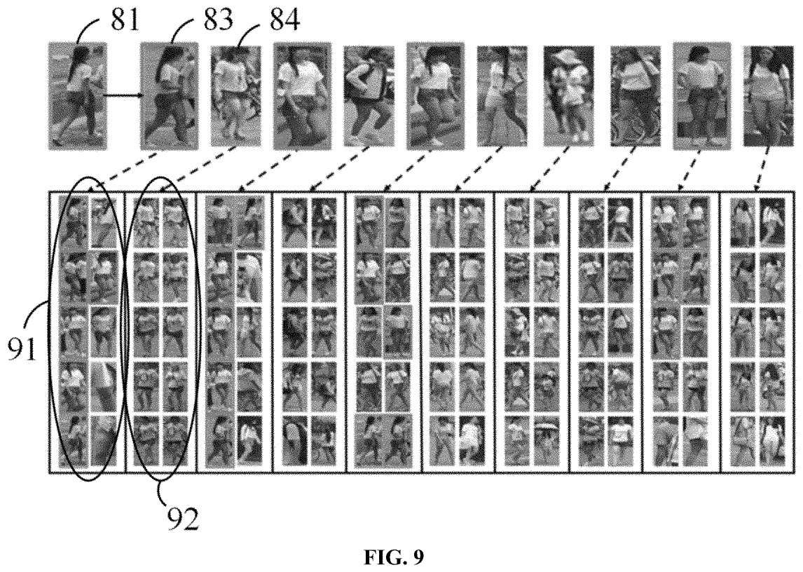

Next, based on ten neighbor images including the library image 83, the library image 84, till the library image 85, a library image that is similar to each of the neighbor images is then retrieved from the image library. Exemplarily, taking the library image 83 as an example, according to the similarity measure of image features, the first ten library images with similarities ranking at the top are selected from the library images as the ten neighbor images of the library image 83. Referring to FIG. 9, a set 91 includes ten library images, and these images are ten neighbor images of the library image 83. In the same way, ten neighbor images similar to the library image 84 may be retrieved again, that is, a set 92 in FIG. 9. Similar images should be retrieved, for each of the ten neighbor images including the library image 83, the library image 84, till the library image 85, which will not be described in detail. The library image 83, library image 84, etc. above may be referred to as first images similar to the sample image 81, and the library images in the set 91 and the set 92 may all be referred to as second images similar to the sample image 81. The first images and the second images are given as examples in the present embodiment. In other application examples, it is also possible to continue to retrieve a third image similar to the second image.

Then, based on the sample image and the retrieved neighbor images, an association graph may be generated. The association graph is similar to that illustrated in FIG. 6, which includes a main node and multiple neighbor nodes. The main node represents the sample image 81. Each neighbor node represents a respective neighbor image, and these neighbor nodes include a first image and also a second image. The node value of each node represents an image feature of the image represented by the node. The image feature is the image feature extracted and used when acquiring neighbor images for comparison of feature similarity. For example, the image feature may be extracted through the above feature extraction network.

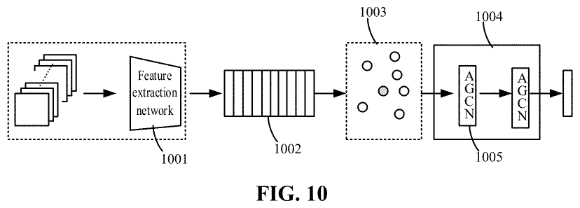

Please refer to FIG. 10, which illustrates a network structure of a feature update network for extracting image features. The network structure may include a feature extraction network 1001. Through the feature extraction network 1001, image features 1002 of a sample image and library images in an image library are respectively extracted, and finally an association graph 1003 is obtained according to the similarity comparison of image features and other processing (some neighbor nodes are illustrated in the figure, and there may be more neighbor nodes used actually). The association graph 1003 may be input into a graph convolution network 1004. The graph convolution network 1004 includes multiple stacked graph convolution modules 1005, and each of the graph convolution modules 1005 may update the image feature of the main node according to the flow illustrated in FIG. 2.

The graph convolution network 1004 may output the finally updated image feature of the main node as the updated image feature of the sample image, may continue to determine predicted information corresponding to the sample image based on the updated image feature, and may calculate a loss corresponding to the sample image according to the predicted information and label information of the sample image.

The loss of each sample image may be calculated according to the above processing flow, and finally the network parameters of the feature update network may be adjusted according to the losses of these sample images, for example, parameters of the graph convolution module and parameters of the feature extraction network. In other embodiments, the network structure illustrated in FIG. 10 may include no feature extraction network, and the association graph may be acquired in other ways.

Conducting Person Search Using the Trained Feature Update Network

1): Taking the network structure of FIG. 10 as an example, the feature extraction network 1001 in FIG. 10 may be used to extract image features of library images in an image library, and save these extracted image features.

2): When a target image to be retrieved is received, for example the target image being a person image, the image feature of the target image may be extracted by the feature update network in the following manner:

Firstly, an image feature of the target image is also extracted through the feature extraction network 1001 in FIG. 10.

Next, a neighbor image of the target image is obtained based on the feature similarities between the image feature of the target image and the image features of the library images. According to the target image and its neighbor images, an association graph may be obtained, and the association graph may include a main node representing the target image and multiple neighbor nodes representing the neighbor images. The association graph is input into the graph convolution network 1004 in FIG. 10, the image feature of the main node in the target image is updated by the graph convolution module 1005, and the finally obtained image feature of the main node is the updated image feature of the target image.

3): For each library image, the same processing mode as 2) may also be followed to obtain the updated image feature of each library image finally output by the graph convolution network 1004.

4): The feature similarity between the updated image feature of the target image and the updated image feature of each library image is calculated, and the library images are sorted according to the similarities to obtain a final retrieval result. For example, several library images with higher similarities may be taken as the retrieval result.

In the method for retrieving an image of the present embodiment, the image features of neighbor images associated with the target image are comprehensively considered when performing image feature extraction. Thus, the image features learned by using the trained feature update network are more robust and discriminative, so as to improve the accuracy of image retrieval. Moreover, the graph convolution module may be stacked in multiple layers, thus having good scalability. In group-wise training, sample images in a batch can be calculated in parallel using a deep learning framework and hardware, improving the efficiency of network training.

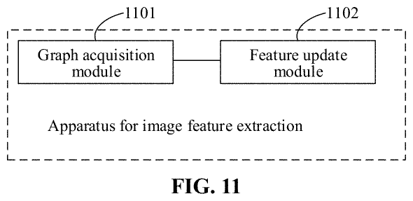

FIG. 11 provides an apparatus for image feature extraction, which may be configured to perform the method for image feature extraction in any one of the embodiments of the disclosure. As illustrated in FIG. 11, the apparatus may include: a graph acquisition module 1101 and a feature update module 1102.

The graph acquisition module 1101 is configured to acquire a first association graph including a main node and at least one neighbor node. A node value of the main node represents an image feature of a target image. A node value of each of the at least one neighbor node represents an image feature of a respective one of at least one neighbor image. The at least one neighbor image is similar to the target image.

The feature update module 1102 is configured to input the first association graph into a feature update network, and update, by the feature update network, the node value of the main node according to the node value of the at least one neighbor node in the first association graph, to obtain an updated image feature of the target image.

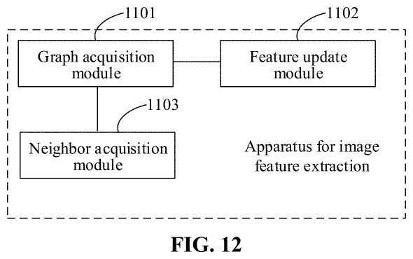

In an example, as illustrated in FIG. 12, the apparatus further includes: a neighbor acquisition module 1103, configured to acquire, from an image library, the at least one neighbor image similar to the target image according to the target image, before the graph acquisition module acquires the first association graph.

In an example, the neighbor acquisition module 1103 is configured to: acquire, through a feature extraction network, an image feature of the target image and an image feature of each of library images in the image library respectively; and determine, from the image library, the at least one neighbor image similar to the target image based on feature similarities between the image feature of the target image and image features of the library images in the image library.

In an example, the neighbor acquisition module 1103 is further configured to: sort the feature similarities between the image feature of the target image and the image features of the library images in a descending order of numeric values of the feature similarities; and select a library image corresponding to a feature similarity ranking at a preset top number among the feature similarities as a neighbor image similar to the target image.

In an example, the neighbor acquisition module 1103 is further configured to: obtain, from the library images, a first image similar to the target image according to the feature similarities between the image feature of the target image and the image features of the library images; obtain, from the library images, a second image similar to the first image according to feature similarities between an image feature of the first image and the image features of the library images; and take the first image and the second image as neighbor images of the target image.

In an example, the feature update network includes one feature update network, or successively stacked N feature update networks, N being an integer greater than 1. In response to that the feature update network includes the successively stacked N feature update networks, an input of an i^{th} of the N feature update networks is an updated first association graph output by an (i−1)^{th} of the N feature update networks, i being an integer greater than 1 and less than or equal to N.

In an example, the feature update module 1102 is configured to: determine a weight of each of the at least one neighbor node with respect to the main node in the first association graph; combine image features of the at least one neighbor node according to respective weights of the at least one neighbor node, to obtain a weighted feature of the main node; and obtain the updated image feature of the target image according to the image feature of the main node and the weighted feature of the main node.

In an example, the feature update module 1102 is further configured to: solve a weighted sum of the image features of the at least one neighbor node according to the respective weights of the at least one neighbor node, to obtain the weighted feature of the main node.

In an example, the feature update module 1102 is further configured to: concatenate the image feature of the main node with the weighted feature of the main node; and perform nonlinear mapping on the concatenated image features to obtain the updated image feature of the target image.

In an example, the feature update module 1102 is further configured to: perform linear transformation on the image feature of the main node and the image feature of each of the at least one neighbor node; determine an inner product of the image feature of main node and the image feature of each of the at least one neighbor node that have subjected to the linear transformation; and perform nonlinear processing on the inner product and determine, according to the inner product having subjected to the nonlinear processing, a respective weight for each of the at least one neighbor node with respect to the main node.

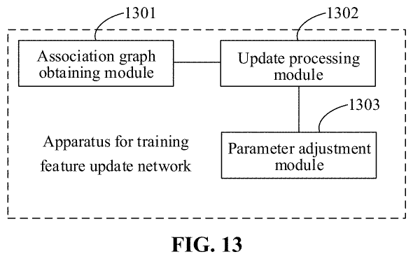

FIG. 13 provides an apparatus for training a feature update network, which may be configured to perform the method for training a feature update network in any one of the embodiments of the disclosure. As illustrated in FIG. 13, the apparatus may include: an association graph obtaining module 1301, an update processing module 1302 and a parameter adjustment module 1303.

The association graph obtaining module 1301 is configured to acquire a second association graph including a training main node and at least one training neighbor node. A node value of the training main node represents an image feature of a sample image. A node value of each of the at least one training neighbor node represents an image feature of a respective one of at least one training neighbor image. The at least one training neighbor image is similar to the sample image

The update processing module 1302 is configured to input the second association graph into the feature update network, and update, by the feature update network, the node value of the training main node according to the node value of the at least one training neighbor node in the second association graph, to obtain an updated image feature of the sample image; and.

The parameter adjustment module 1303 is configured to obtain predicted information of the sample image according to the updated image feature of the sample image, and adjust a network parameter of the feature update network according to the predicted information.

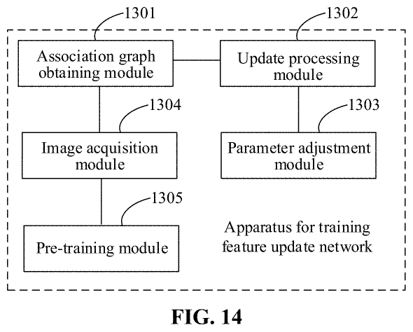

In an example, as illustrated in FIG. 14, the apparatus further includes: an image acquisition module 1304, configured to acquire, from a training image library, the at least one training neighbor image similar to the sample image according to the sample image, before the association graph obtaining module acquires the second association graph.

In an example, as illustrated in FIG. 14, the apparatus further includes a pre-training module 1305.

The pre-training module 1305 is configured to: extract an image feature of a training image through a feature extraction network; obtain predicted information of the training image according to the image feature of the training image; and adjust a network parameter of the feature extraction network based on the predicted information of the training image and label information. The training image is configured to train the feature extraction network, and the sample image is configured to train the feature update network after training completion of the feature extraction network is completed.

The image acquisition module 1304 is configured to: acquire, through the feature extraction network, an image feature of the sample image and an image feature of each of library images in the training image library respectively; and determine the at least one training neighbor image similar to the sample image based on feature similarities between the image feature of the sample image and image features of the library images.

In some embodiments, the functions or modules contained in the apparatus provided in the embodiment of the disclosure may be configured to perform the methods described in the above method embodiments. The specific implementation may refer to the description of the above method embodiments. For brevity, descriptions are omitted herein.

In at least one embodiment of the disclosure, an electronic device is provided. The device may include a memory and a processor. The memory is configured to store computer instructions executable by the processor, and the processor is configured to execute the computer instructions to implement the method for image feature extraction or the method for training a feature update network in any one of the embodiments of the disclosure.

In at least one embodiment of the disclosure, a computer-readable storage medium having a computer program stored thereon is provided. The device may include a memory and a processor. The program, when executed by a processor, implements the method for image feature extraction or the method for training a feature update network in any one of the embodiments of the disclosure.

In at least one embodiment of the disclosure, provided a computer program for causing a processor to perform the steps of the method for image feature extraction or the method for training a feature update network in any one of the embodiments of the disclosure.

Those skilled in the art should understand that one or more embodiments of the disclosure may be provided as a method, a system, or a computer program product. Therefore, one or more embodiments of the disclosure may take the form of an entirely hardware embodiment, an entirely software embodiment, or an embodiment combining software and hardware. Moreover, one or more embodiments of the disclosure may take the form of a computer program product implemented on one or more computer-available storage media (including but not limited to a disk memory, a compact disc read-only memory (CD-ROM), an optical memory, etc.) containing computer-available program code.

An embodiment of the disclosure also provides a computer-readable storage medium, on which a computer program may be stored. The program, when executed by a processor, implements the steps of the method for image feature extraction described in any embodiment of the disclosure, and/or, implement the steps of the method for training a feature update network described in any embodiment of the disclosure. The “and/or” means at least one of the two, for example, “A and/or B” includes three schemes: A, B, and “A and B”.

The embodiments in the disclosure are described in a progressive manner. The same or similar parts between the embodiments can be referred to each other, and each embodiment focuses on the differences from other embodiments. In particular, for the embodiment of the data processing device, since it is basically similar to the method embodiment, the description is relatively simple, and the relevant part can be referred to the description of the method embodiment.

The foregoing describes specific embodiments of the disclosure. Other embodiments are within the scope of the appended claims. In some cases, the actions or steps recited in the claims may be performed in a different order than in the embodiments and still achieve the desired results. In addition, the processes depicted in the drawings do not necessarily require the particular order illustrated or sequential order to achieve the desired results. In some embodiments, multitasking and parallel processing are also possible or may be advantageous.

Embodiments of the subject matter and functional operations described in the disclosure may be implemented in: digital electronic circuits, tangibly embodied computer software or firmware, computer hardware including the structures disclosed in the disclosure and their structural equivalents, or one or more combinations thereof. Embodiments of the subject matter described in the disclosure may be implemented as one or more computer programs, that is, one or more modules of computer program instructions encoded on a tangible non-transitory program carrier so as to be executed by a data processing apparatus or to control the operation of the data processing device. Alternatively or additionally, the program instructions may be encoded on an artificially generated propagation signal, such as a machine-generated electrical, optical, or electromagnetic signal, which is generated to encode and transmit the information to a suitable receiver apparatus so as to be executed by the data processing apparatus. The computer storage medium may be a machine-readable storage device, a machine-readable storage substrate, a random or serial access memory device, or a combination of one or more of them.

The processes and logic flows described in the disclosure may be performed by one or more programmable computers that execute one or more computer programs to perform corresponding functions by operating according to input data and generating output. The processing and logic flow may also be performed by dedicated logic circuits such as a Field Programmable Gate Array (FPGA) or an Application Specific Integrated Circuit (ASIC), and the apparatus may also be implemented as a dedicated logic circuit.

Computers suitable for executing computer programs include, for example, general-purpose and/or special-purpose microprocessors, or any other type of central processing unit. Generally, the central processing unit will receive instructions and data from a read-only memory and/or a random access memory. The basic components of a computer include a central processing unit for implementing or executing instructions and one or more memory devices for storing instructions and data. Typically, the computer will also include one or more mass storage devices for storing data, such as magnetic disks, magneto-optical disks, or optical disks, or the computer will be operably coupled to the mass storage device to receive data from or transmit data to it, or both.

However, the computer does not necessarily have such a device. In addition, the computer may be embedded in another device, such as a mobile phone, a Personal Digital Assistant (PDA), a mobile audio or video player, a game console, a Global Positioning System (GPS) receiver, or a portable storage device such as a Universal Serial Bus (USB) flash drive, to name a few.

Computer-readable media suitable for storing computer program instructions and data include all forms of non-volatile memory, media, and memory devices, including, for example, semiconductor memory devices (such as electrically programmable read-only memories (EPROMs), electrically erasable programmable read-only memories (EEPROMs), and flash memory devices), magnetic disks (such as internal hard drives, or mobile disks), magneto-optical disks, CD ROMs and digital video disk ROM (DVD-ROM) disks. The processor and the memory may be supplemented by, or incorporated in, dedicated logic circuits.

Although the disclosure contains many specific implementation details, these should not be construed as limiting the scope of any disclosure or the claimed scope, but are mainly used to describe features of specific embodiments of particular disclosures. Certain features described in multiple embodiments within the disclosure may also be implemented in combination in a single embodiment. On the other hand, various features described in a single embodiment may also be implemented separately in multiple embodiments or in any suitable sub-combination. In addition, although features may function in certain combinations as described above and even initially claimed as such, one or more features from the claimed combination may, in some cases, be removed from the combination and the claimed combinations may point to sub-combinations or variations of sub-combinations.

Similarly, although the operations are depicted in a specific order in the drawings, this should not be construed as requiring these operations to be performed in the specific order illustrated or sequentially, or requiring all illustrated operations to be performed to achieve the desired result. In some cases, multitasking and parallel processing may be advantageous. In addition, the separation of various system modules and components in the above embodiments should not be understood as requiring such separation in all embodiments, and it should be understood that the described program components and systems may generally be integrated together in a single software product, or packaged into multiple software products.

Thus, specific embodiments of the subject matter have been described. Other embodiments are within the scope of the appended claims. In some cases, the actions recited in the claims may be performed in a different order and still achieve the desired results. In addition, the processes depicted in the drawings are not necessarily in the specific order illustrated or sequential order to achieve the desired results. In some implementations, multitasking and parallel processing may be advantageous.

The above are only preferred embodiments of one or more embodiments of the disclosure, and are not intended to limit one or more embodiments of the disclosure. Any modifications, equivalent replacements, improvements, etc., made within the spirit and principle of one or more embodiments of the disclosure should be included within the scope of protection of one or more embodiments of the disclosure.

1. A method for image feature extraction, comprising:
acquiring a first association graph comprising a main node and at least one neighbor node, wherein a node value of the main node represents an image feature of a target image, a node value of each of the at least one neighbor node represents an image feature of a respective one of at least one neighbor image, and the at least one neighbor image is similar to the target image; and
inputting the first association graph into a feature update network, and updating, by the feature update network, the node value of the main node according to the node value of the at least one neighbor node in the first association graph, to obtain an updated image feature of the target image.

2. The method according to claim 1, wherein before acquiring the first association graph, the method further comprises:
acquiring, from an image library, the at least one neighbor image similar to the target image according to the target image.

3. The method according to claim 2, wherein acquiring, from the image library, the at least one neighbor image similar to the target image according to the target image comprises:
acquiring, through a feature extraction network, an image feature of the target image and an image feature of each of library images in the image library respectively; and
determining, from the image library, the at least one neighbor image similar to the target image based on feature similarities between the image feature of the target image and image features of the library images in the image library.

4. The method according to claim 3, wherein determining, from the image library, the at least one neighbor image similar to the target image based on the feature similarities between the image feature of the target image and the image features of the library images in the image library comprises:
sorting the feature similarities between the image feature of the target image and the image features of the library images in a descending order of numeric values of the feature similarities; and
selecting a library image corresponding to a feature similarity ranking at a preset top number among the feature similarities as a neighbor image similar to the target image.

5. The method according to claim 3, wherein determining, from the image library, the at least one neighbor image similar to the target image based on the feature similarities between the image feature of the target image and the image features of the library images in the image library comprises:
obtaining, from the library images, a first image similar to the target image according to the feature similarities between the image feature of the target image and the image features of the library images;
obtaining, from the library images, a second image similar to the first image according to feature similarities between an image feature of the first image and the image features of the library images; and
taking the first image and the second image as neighbor images of the target image.

6. The method according to claim 1, wherein the feature update network comprises one feature update network, or successively stacked N feature update networks, N being an integer greater than 1; and
in response to that the feature update network comprises the successively stacked N feature update networks, an input of an i^{th} of the N feature update networks is an updated first association graph output by an (i−1)^{th} of the N feature update networks, i being an integer greater than 1 and less than or equal to N.

7. The method according to claim 1, wherein updating, by the feature update network, the node value of the main node according to the node value of the at least one neighbor node in the first association graph, to obtain the updated image feature of the target image comprises:
determining a weight of each of the at least one neighbor node with respect to the main node in the first association graph;
merging image features of the at least one neighbor node according to respective weights of the at least one neighbor node, to obtain a weighted feature of the main node; and
obtaining the updated image feature of the target image according to the image feature of the main node and the weighted feature of the main node.

8. The method according to claim 7, wherein merging the image features of the at least one neighbor node according to the respective weights of the at least one neighbor node, to obtain the weighted feature of the main node comprises:
solving a weighted sum of the image features of the at least one neighbor node according to the respective weights of the at least one neighbor node, to obtain the weighted feature of the main node.

9. The method according to claim 7, wherein obtaining the updated image feature of the target image according to the image feature of the main node and the weighted feature of the main node comprises:
concatenating the image feature of the main node with the weighted feature of the main node; and
performing nonlinear mapping on the concatenated image features to obtain the updated image feature of the target image.

10. The method according to claim 7, wherein determining a weight of each of the at least one neighbor node with respect to the main node in the first association graph comprises:
performing linear transformation on the image feature of the main node and the image feature of each of the at least one neighbor node;
determining an inner product of the image feature of the main node and the image feature of each of the at least one neighbor node that have subjected to the linear transformation; and
performing nonlinear processing on the inner product and determining, according to the inner product having subjected to the nonlinear processing, a respective weight of each of the at least one neighbor node with respect to the main node.

11. The method according to claim 1, wherein the target image comprises one of: a query image to be retrieved and library images in an image library;
after obtaining the updated image feature of the target image, the method further comprises:
obtaining, from the library images, an image similar to the target image as a retrieval result based on feature similarities between the updated image feature of the target image and image features of the library images.

12. The method according to claim 1, wherein the feature update network is obtained through a training method, and the training method comprises:
acquiring a second association graph comprising a training main node and at least one training neighbor node, wherein a node value of the training main node represents an image feature of a sample image, a node value of each of the at least one training neighbor node represents an image feature of a respective one of at least one training neighbor image, and the at least one training neighbor image is similar to the sample image;
inputting the second association graph into the feature update network, and updating, by the feature update network, the node value of the training main node according to the node value of the at least one training neighbor node in the second association graph, to obtain an updated image feature of the sample image;
obtaining predicted information of the sample image according to the updated image feature of the sample image; and
adjusting a network parameter of the feature update network according to the predicted information.

13. The method according to claim 12, wherein before acquiring the second association graph, the training method further comprises:
acquiring, from a training image library, the at least one training neighbor image similar to the sample image according to the sample image.

14. The method according to claim 13, wherein before acquiring, from the training image library, the at least one training neighbor image similar to the sample image according to the sample image, the training method further comprises:
extracting an image feature of a training image through a feature extraction network;
obtaining predicted information of the training image according to the image feature of the training image; and
adjusting a network parameter of the feature extraction network based on the predicted information of the training image and label information; and
wherein acquiring, from the training image library, the at least one training neighbor image similar to the sample image according to the sample image comprises:
acquiring, through the feature extraction network, an image feature of the sample image and an image feature of each of library images in the training image library respectively; and
determining the at least one training neighbor image similar to the sample image based on feature similarities between the image feature of the sample image and image features of the library images.

15. An electronic device, comprising a memory and a processor, wherein the memory is configured to store computer instructions executable by the processor, and the processor is configured to execute the computer instructions to:
acquire a first association graph comprising a main node and at least one neighbor node, wherein a node value of the main node represents an image feature of a target image, a node value of each of the at least one neighbor node represents an image feature of a respective one of at least one neighbor image, and the at least one neighbor image is similar to the target image; and
input the first association graph into a feature update network, and update, by the feature update network, the node value of the main node according to the node value of the at least one neighbor node in the first association graph, to obtain an updated image feature of the target image.

16. The electronic device according to claim 15, wherein the processor is configured to execute the computer instructions to:
acquire, from an image library, the at least one neighbor image similar to the target image according to the target image, before acquiring the first association graph.

17. The electronic device according to claim 16, wherein in acquiring, from the image library, the at least one neighbor image similar to the target image according to the target image, the processor is configured to execute the computer instructions to:
acquire, through a feature extraction network, an image feature of the target image and an image feature of each of library images in the image library respectively; and
determine, from the image library, the at least one neighbor image similar to the target image based on feature similarities between the image feature of the target image and image features of the library images in the image library.

18. The electronic device according to claim 17, wherein in determining, from the image library, the at least one neighbor image similar to the target image based on the feature similarities between the image feature of the target image and the image features of the library images in the image library, the processor is configured to execute the computer instructions to:
sort the feature similarities between the image feature of the target image and the image features of the library images in a descending order of numeric values of the feature similarities; and
select a library image corresponding to a feature similarity ranking at a preset top number among the feature similarities as a neighbor image similar to the target image.

19. The electronic device according to claim 17, wherein in determining, from the image library, the at least one neighbor image similar to the target image based on the feature similarities between the image feature of the target image and the image features of the library images in the image library, the processor is configured to execute the computer instructions to:
obtain, from the library images, a first image similar to the target image according to the feature similarities between the image feature of the target image and the image features of the library images;
obtain, from the library images, a second image similar to the first image according to feature similarities between an image feature of the first image and the image features of the library images; and
take the first image and the second image as neighbor images of the target image.

20. A non-transitory computer-readable storage medium having a computer program stored thereon, wherein the computer program, when executed by a processor, implements a method for image feature extraction, the method comprising:
acquiring a first association graph comprising a main node and at least one neighbor node, wherein a node value of the main node represents an image feature of a target image, a node value of each of the at least one neighbor node represents an image feature of a respective one of at least one neighbor image, and the at least one neighbor image is similar to the target image; and
inputting the first association graph into a feature update network, and updating, by the feature update network, the node value of the main node according to the node value of the at least one neighbor node in the first association graph, to obtain an updated image feature of the target image.
